(19) United States
(12) Patent Application Publication
(10) Pub. No.: US 2012/0241662 A1
(43) Pub. Date: Sep. 27, 2012

(54) INTERCHANGEABLE VALVE APPARATUS FOR USE WITH FLUID REGULATORS

(76) Inventors: Jason David Clifford, Brooklyn Park, MN (US); Thomas William Logan, Rogers, MN (US)

(21) Appl. No.: 13/052,476

(22) Filed: Mar. 21, 2011

(51) Int. Cl. F16K 27/00

(52) U.S. Cl. 251/356

(57) ABSTRACT

Interchangeable valve apparatus for use with fluid regulators are described herein. An example valve apparatus described herein includes a first retainer is removably coupled to a fluid flow passageway of a fluid regulator between an inlet and an outlet. The first retainer comprises a first housing having a first bore to receive a flow control assembly and the first retainer has a first opening coaxially aligned with the first bore to define a first orifice of the fluid flow passageway when the retainer is coupled to the fluid regulator. The fluids regulator also includes a second retainer different than and interchangeable with the first retainer, where the second retainer comprises a second housing having a second bore to receive the flow control assembly. The second retainer has a second opening coaxially aligned with the second bore to define a second orifice of the fluid flow passageway when the second retainer is coupled to the fluid regulator. The first retainer provides a first fluid flow characteristic and the second retainer provides a second fluid flow characteristic different than the first fluid flow characteristic.

### FIELD OF THE DISCLOSURE

This patent relates generally to fluid regulators and, more particularly, to interchangeable valve apparatus for use with fluid regulators.

### BACKGROUND

Fluid regulators are commonly distributed throughout process control systems to control the pressures of various fluids (e.g., liquids, gasses, etc.). Fluid regulators are typically used to regulate the pressure of a fluid to a substantially constant value. Specifically, a fluid regulator has an inlet that typically receives a supply fluid at a relatively high pressure and provides a relatively lower and substantially constant pressure at an outlet.

To regulate the downstream pressure, fluids regulators commonly include a sensing element or diaphragm to sense an outlet pressure in fluid communication with a downstream pressure. A valve apparatus is disposed within the fluid flow passageway to control or modulate fluid flow through an orifice between an inlet and the outlet. The valve apparatus typically includes a flow control member that moves relative to a seating surface or valve seat that defines the orifice of the fluid flow passageway. A fluid regulator with a given orifice size or geometry provides a particular or maximum fluid flow capacity or flow rate at a given pressure drop (e.g., a fluid flow coefficient). To provide different fluid flow capacities, a flow control member, a retainer and/or a valve seat are often replaced or altered to characterize an orifice to provide a desired fluid flow capacity. In some instances, a different fluid regular having a differently sized valve body (e.g., a differently sized fluid flow passageway) may be required to achieve a desired fluid flow rate, capacity or flow coefficient with a particular orifice.

### SUMMARY

In one example, a first retainer is removably coupled to a fluid flow passageway of a fluid regulator between an inlet and an outlet. The first retainer comprises a first housing having a first bore to receive a flow control assembly and the first retainer has a first opening coaxially aligned with the first bore to define a first orifice of the fluid flow passageway when the retainer is coupled to the fluid regulator. The fluids regulator also includes a second retainer different than and interchangeable with the first retainer, where the second retainer comprises a second housing having a second bore to receive the flow control assembly. The second retainer has a second opening coaxially aligned with the second bore to define a second orifice of the fluid flow passageway when the second retainer is coupled to the fluid regulator. The first retainer provides a first fluid flow characteristic and the second retainer provides a second fluid flow characteristic different than the first fluid flow characteristic.

In another example, a fluid regulator includes a valve cartridge removably coupled to a valve body of the fluid regulator to define at least a portion of a fluid flow passageway between an inlet and an outlet of the valve body. The valve cartridge includes a plurality of different and interchangeable retainers for use with the fluid regulator, where each retainer has an orifice to define a different respective fluid flow capacity of the fluid regulator. The valve cartridge also includes a flow control assembly disposed within a cavity of a first retainer selected from the plurality of retainers and a sealing member coupled to an end of the first retainer to hold the flow control assembly within the cavity.

In yet another example, a modular valve apparatus includes a first retainer having a first cavity to receive a movable flow control member and a first shoulder that defines a first valve seat. The first valve seat defines a first orifice providing a first fluid flow capacity of the fluid regulator when the first retainer is coupled to the fluid regulator. A poppet is disposed within the first cavity and movable relative to the first valve seat to control fluid flow across the first orifice and a seal is coupled to an end of the first retainer to retain the poppet within the first cavity of the first retainer. The valve apparatus also includes a second retainer that is interchangeable with and different than the first retainer, where the second retainer has a second cavity to receive the movable flow control member and a second shoulder that defines a second valve seat. The second valve seat defines a second orifice that provides a second fluid flow capacity when the second retainer is coupled to the fluid regulator, where the first fluid flow capacity is different than the second fluid flow capacity.

### BRIEF DESCRIPTION OF THE DRAWINGS

FIG. 1A illustrates a known fluid regulator.

FIG. 2 illustrates a fluid regulator having an example valve cartridge described herein.

FIG. 3 illustrates the example valve cartridge of FIG. 2.

FIG. 4 illustrates a fluid regulator having another example valve cartridge described herein.

FIG. 5 illustrates the example valve cartridge of FIG. 4

### DETAILED DESCRIPTION

Example modular valve apparatus or valve cartridges described herein enable interchangeability between different retainers, each of which may be coupled to a fluid regulator to provide a different respective fluid flow capacity. In particular, the example modular valve apparatus described herein may include a plurality of different and interchangeable retainers for use with a fluid regulator, where each retainer has an orifice that defines a different maximum fluid flow capacity or flow rate of a fluid regulator at a given pressure drop across the fluids regulator. For example, a maximum flow rate can be related to a flow coefficient (Cᵥ) that is used to classify or predict the flow rate through a fluid regulator under a standard condition. For example, the flow coefficient value may be defined as the number of U.S. gallons per minute of 60° F. water that will flow through a fluid regulator with a pressure drop of one pound per square inch (psi) across an orifice.

As a result of the interchangeability provided by the valve cartridges described herein, fewer total components may be needed to provide a greater variety of fluid flow characteristics or capacities of fluid regulators than conventional fluid regulators. In other words, with the example valve cartridges described herein, it may not be necessary to manufacture and inventory every possible combination of a valve seat, a valve body and/or orifice configuration as is typically required with known valve apparatus or fluid regulators to provide different fluid flow capacities or fluid flow characteristics. Instead, only an interchangeable or replaceable retainer component needs to be manufactured and stocked and the different retainers can be made as needed to suit particular applications.

In other words, the interchangeable retainers may be used to provide an array of flow characteristics while still using the same flow control assembly components or parts. For example, each retainer may have a different sized orifice to provide a fluid flow characteristic associated with a fluid flow coefficient of between approximately slightly greater than zero and 0.50 using substantially the same components of the valve apparatus. For example, a first retainer may have an orifice that provides a fluid flow capacity classified by a flow coefficient of, for example, approximately 0.06 and a second retainer may have an orifice that provides a fluid flow capacity classified by a flow coefficient of, for example, approximately 0.2. Additionally, the retainers may be configured to receive a substantially similar fluid flow assembly and may be configured to be coupled to a similar valve body of a fluid regulator.

Further, the example retainers described herein may include one or more fluid flow paths to support increased flow rates that may result from an orifice sized to provide a greater or increased fluid flow capacity. For example, a flange of the retainer may include one or more fluid flow paths that are substantially perpendicular to the orifice of the fluid regulator to fluidly couple the orifice and a sensing chamber of the fluid regulator.

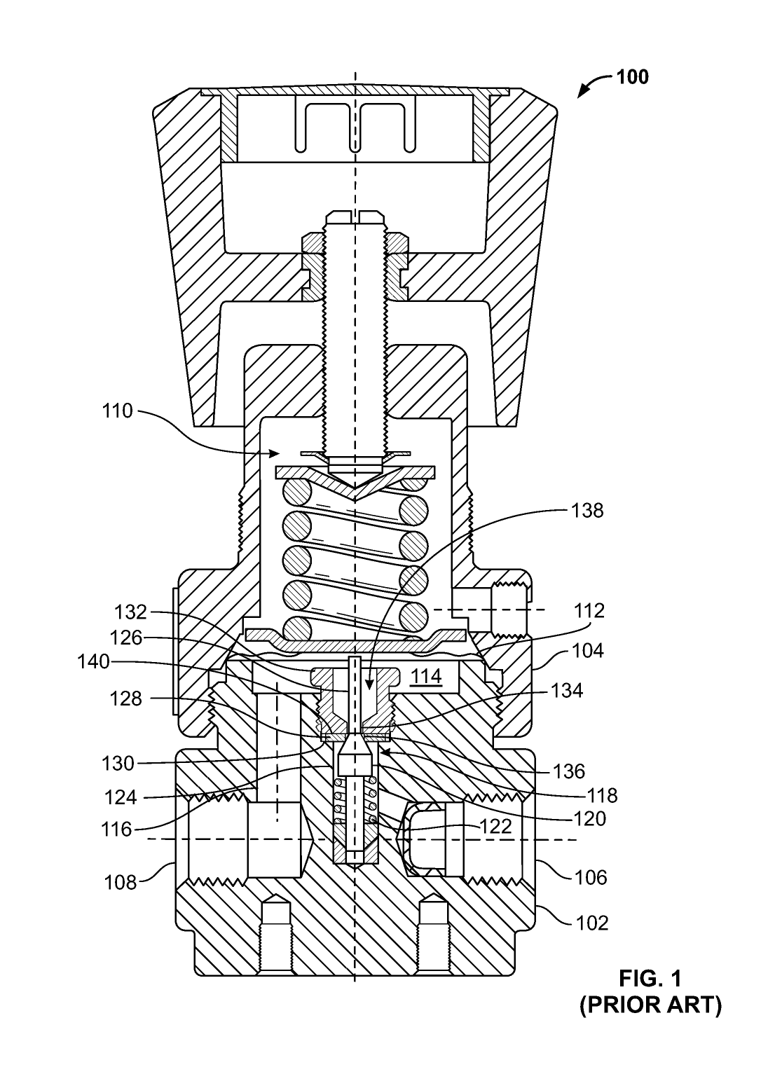

Before discussing an example fluid regulator described herein, a brief description of a known fluid regulator 100 is provided in FIG. 1. Referring to FIG. 1, the example fluid regulator 100 includes a valve body 102 threadably coupled to a bonnet 104 that defines a fluid passageway between an inlet 106 and an outlet 108. A load assembly 110 is disposed within the bonnet 104 to provide a load to a diaphragm 112, where the load corresponds to a desired fluid outlet pressure. The diaphragm 112 is captured between the bonnet 104 and the valve body 102 such that the diaphragm 112 and the valve body 102 define a sensing chamber 114 that is in fluid communication with the outlet 108 via a passageway 116.

The fluid regulator 100 includes a valve apparatus or assembly 118 to control fluid flow through the fluid regulator 100. The valve apparatus 118 includes a poppet 120 and a biasing element 122 disposed within a bore 124 of the valve body 102. The poppet 120 also includes a stem 126 to operatively couple the diaphragm 112 and the poppet 120. A valve seat 128 is disposed within the bore 124 and supported on a shoulder 130 of the bore 124. A retainer 132 is threadably coupled to the bore 124 of the valve body 102 to retain the valve seat 128, the biasing element 122 and the poppet 120 within a bore 124 of the valve body 102. The biasing element 122 is disposed between the retainer 132 and the valve seat 128 to bias the poppet 120 toward the valve seat 128.

In operation, the diaphragm 112 moves relative to the stem 126 to cause the poppet 120 to move relative to the valve seat 128 based on a pressure differential on opposing sides of the diaphragm 112. The diaphragm 112 moves relative to (e.g., engages) the stem 126 to cause the poppet 120 to move relative to the valve seat 128 to regulate or modulate fluid flow between the inlet 106 and the outlet 108. The pressurized fluid flows between the inlet 106 and the outlet 108 until the forces on the opposing sides of the diaphragm 112 are balanced.

The poppet 120, the retainer 132 and the valve seat 128 provide a fluid flow capacity, characteristic, or performance of the fluid regulator 100. In particular, the valve seat 128 includes an opening 134 and the retainer includes an opening 136 that together define a fluid orifice 138 of the fluid flow passageway through the fluid regulator 100. The orifice 138 defines or controls a fluid flow capacity of the fluid regulator 100. For example, the orifice 138 may provide a fluid flow capacity that corresponds to a fluid flow coefficient of 0.06.

The opening 136 of the retainer 132 is coaxially aligned with the opening 134 of the valve seat 128 and sized substantially similar to the opening 134 of the valve seat 128 so that a body portion 140 of the retainer 132 supports the valve seat 128 when the retainer 132 is coupled to the valve body 102. Forming the retainer 132 with an opening sized larger than the opening 134 of the valve seat 128 may provide inadequate support to the valve seat 128.

Thus, to provide different fluid flow capacities or characteristics, a different valve seat and/or retainer may be required. For example, the retainer 132 and the valve seat 128 of the fluid regulator 100 may be replaced with another valve seat and retainer having differently sized openings. For example, to provide a greater fluid flow capacity, openings of the valve seat 128 and the retainer 132 can be sized larger than the openings 134 and 136 of the valve seat 128 and the retainer 132, respectively. However, a fluid flow path (e.g., the bore 124) of the fluid regulator 100 may be insufficient (e.g., sized too small) to handle or support a fluid flow rate associated with a fluid flow performance or capacity provided by an orifice that permits a greater fluid flow capacity. Thus, another valve body having a larger fluid flow passageway (e.g., a larger bore 124) may be required to achieve the desired flow characteristic(s). As a result, a greater number of components are needed to provide a greater variety of fluid flow performances or capacities of fluid regulators, thereby increasing manufacturing and inventory costs.

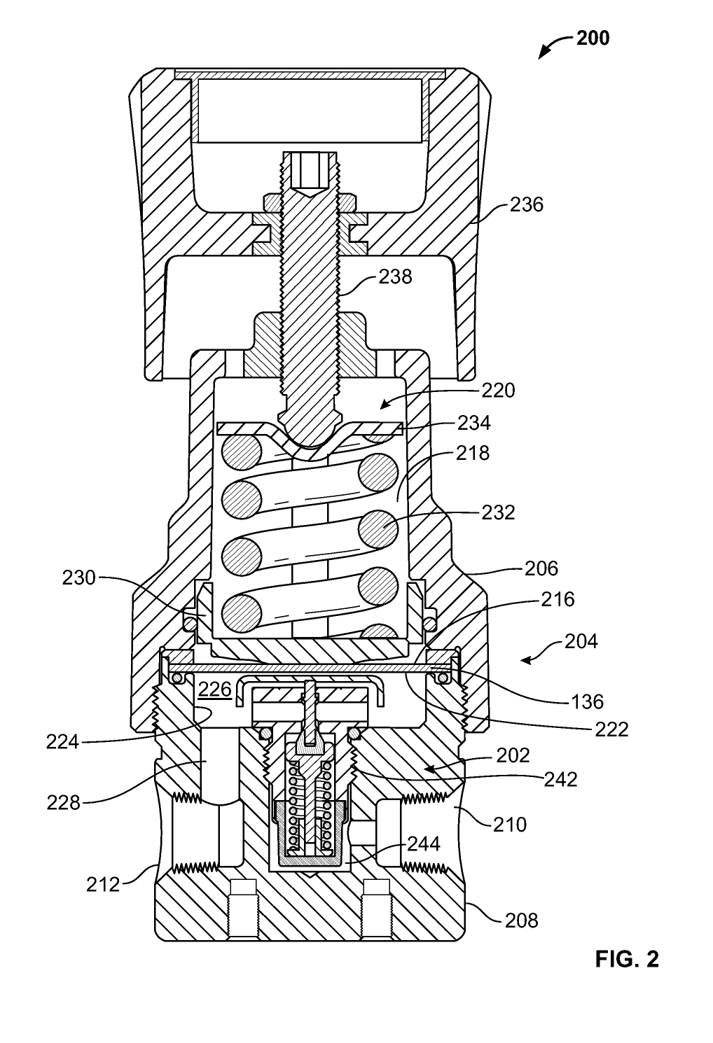

FIG. 2 illustrates an example fluid regulator 200 having a valve cartridge or valve apparatus 202 described herein. Referring to FIG. 2, the example fluid regulator 200 includes a regulator body 204 having an upper body portion or bonnet 206 coupled (e.g., threadably coupled) to a lower body portion or valve body 208. The valve body 208 forms a fluid flow passageway between an inlet 210 and an outlet 212 of the fluid regulator 200. A diaphragm 214 is captured between the valve body 208 and the bonnet 206 so that a first side 216 of the diaphragm 214 and the bonnet 206 define a load chamber 218 to receive a load assembly 220. A second side 222 of the diaphragm 214 and an inner surface 224 of the valve body 208 define a sensing chamber 226. The sensing chamber 226 is fluidly coupled to the outlet 212 via a passage 228 and senses the pressure of the fluid at the outlet 212.

The load assembly 220 is operatively coupled to the diaphragm 214 via a diaphragm plate or back-up plate 230 and provides a reference force or load (e.g., a pre-set force) to the diaphragm 214. In this example, the load assembly 220 includes a biasing element 232 (e.g., a spring) disposed within the load chamber 218 that provides a load to the diaphragm 214 via the diaphragm plate 230. The biasing element 232 seats between the diaphragm plate 230 and a spring button 234 that is operatively coupled to a spring adjustor 236 via a screw 238. The spring adjustor 236 moves the biasing element 232 via the spring button 234 to adjust (e.g., increase or decrease) the amount of a preset force or load that the biasing element 232 exerts on the first side 216 of the diaphragm 214. For example, rotation of the spring adjustor 236 in a first direction (e.g., a clockwise direction) or a second direction (e.g., a counterclockwise direction) varies the amount of compression of the biasing element 232 (e.g., compresses or decompresses the biasing element 232) and, thus, the amount of load exerted on the first side 216 of the diaphragm 214.

To control or modulate fluid flow between the inlet 210 and the outlet 212, the fluid regulator 200 employs the valve apparatus or valve cartridge 202. The valve apparatus 202 of the illustrated example is disposed within a bore or opening 242 (e.g., a threaded opening) of the valve body 208 that defines an inlet chamber 244 fluidly coupled to the inlet 210. The valve apparatus 202 is operatively coupled to the diaphragm 214 such that the diaphragm 214 causes the valve apparatus 202 to move between an open position to allow fluid flow through the passageway and a closed position to restrict fluid flow through the passageway based on a pressure differential between the sides 216 and 222 of the diaphragm 214.

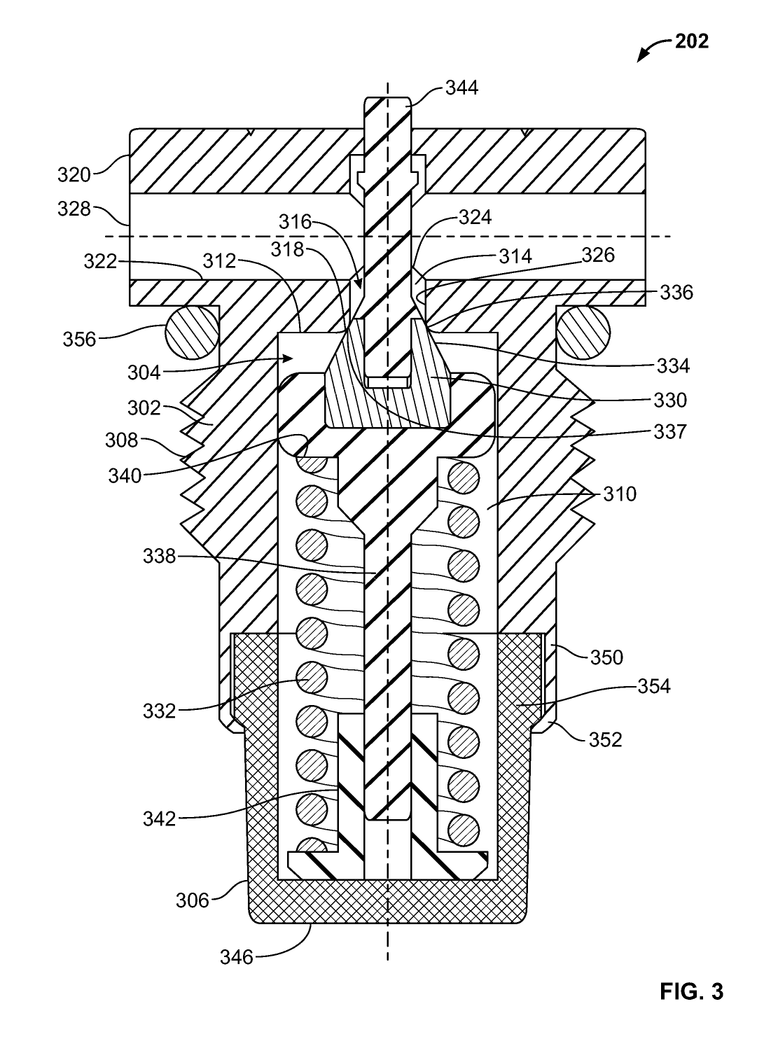

FIG. 3 is an enlarged view of the valve apparatus 202 of FIG. 2. The valve apparatus 202 of the illustrated example is a subassembly that removably couples to the valve body 208. The valve apparatus 202 includes an interchangeable or replaceable housing or retainer 302, a flow control assembly 304 and a closure member or filter 306.

The retainer 302 of the illustrated example is a cylindrically-shaped body having a threaded portion 308 to threadably couple the valve apparatus 202 to the opening 242 of the valve body 208 of the fluid regulator 200. The retainer 302 includes a cavity or bore 310 to at least partially define the fluid flow passageway of the fluid regulator 200 when the valve apparatus 202 is coupled to the valve body 208. The retainer 302 and the bore 310 form a shoulder 312 having an opening 314 coaxially aligned with the bore 310 to define a fluid orifice 316 of the fluid regulator 200 when the retainer 302 is coupled to the valve body 208. In particular, the orifice 316 provides a particular or maximum fluid flow capacity or fluid flow characteristic of the fluid regulator 200. For example, the orifice 316 may have a diameter or size to provide a maximum fluid flow capacity corresponding to a flow coefficient of approximately 0.06.

In the illustrated example, the shoulder 312 defines a valve seat 318 of the fluid flow passageway. Further, the retainer 302 includes a flange 320 having a fluid flow path 322 that has a first portion or inlet 324 in fluid communication with an outlet 326 of the valve seat 318 and a second portion or outlet 328 in fluid communication with the sensing chamber 226 (FIG. 2). The fluid flow path 322 supports a fluid flow rate associated with the fluid flow capacity (or a fluid flow coefficient) provided by the orifice 316. The fluid flow path 322 of the illustrated example is substantially perpendicular to the opening 314 and/or the bore 310 and is downstream from the valve seat 318. Additionally, an upper surface 321 of the flange 320 may include one or more openings (not shown) to allow fluid flow to the sensing chamber 226. In yet other examples, the upper surface 321 may be removed. As shown, the retainer 302 has a T-shaped cross-sectional shape or profile. However, in other examples, the retainer 302 may any suitable cross-sectional shape or profile.

The flow control assembly 304 is disposed within the bore 310 to control fluid flow across the orifice 316 between the inlet 210 and the outlet 212. In particular, the retainer 302 (e.g., the bore 310 and the shoulder 312) defines a common flow control assembly interface. In this example, the flow control assembly 304 includes a movable poppet 330 and a biasing element 332 (e.g., a spring). The poppet 330 is disposed within the bore 310 of the retainer 302 and moves relative to the shoulder 312 or the valve seat 318 of the retainer 302. The poppet 330 includes a sealing surface 334 that engages a seating surface 336 provided by the valve seat 318. In particular, the sealing surface 334 of the poppet 330 and the seating surface 336 of the valve seat 318 have a tapered shape or profile such that a portion 337 of the sealing surface 334 sealingly engages the valve seat 318 to substantially restrict or prevent fluid flow through the orifice 316 when the valve apparatus 202 is in a closed position as shown in FIG. 3. In this example, the shape or profile of the sealing surface 334 of the poppet 330 is complementary to the shape or profile of the seating surface 336 of the valve seat 318.

A poppet retainer 338 is coupled to the poppet 330 to hold the poppet 330. Although not shown, a base 339 of the poppet retainer 338 has a square shaped cross-section such that outer edges (not shown) of the base 339 are away from an inner surface 441 of the bore 310 to allow fluid flow between the inlet 210 and the valve seat 314. In other words, the poppet retainer 338 does not affect fluid flow through the bore 310 and to the valve seat 314. The biasing element 332 is disposed within the bore 310 between a shoulder 340 of the poppet retainer 338 and a spring seat 342 to bias the poppet 330 toward the valve seat 318. A connector stem or push rod 344 is coupled to the poppet 330 to operatively couple the poppet 330 to the diaphragm 214 (FIG. 2). An end 346 of the connector stem is guided (e.g., slides within) an opening 348 of the upper surface 321 of the flange 320.

In this example, the valve apparatus 202 also includes the filter 306 (e.g., a sintered metal or screen) coupled to the retainer 302. The filter 306 is disposed within the inlet chamber 244 (FIG. 2) to filter or prevent impurities (e.g., debris, contaminates, etc.) from flowing in the fluid flow passageway. In this example, an end 350 of the retainer 302 includes tabs, clips or fingers 352 to receive an enlarged portion 354 of the filter 306. More specifically, the filter 306 is coupled to the end 350 of the retainer 302 via a crimp, press fit, snap-fit, interference fit, etc. Thus, in addition to filtering impurities in the fluid flow passageway, the filter 306 retains or holds the flow control assembly 304 within the bore 310 of the retainer 302. In other examples, a filter may be disposed in the bore 310 and a cap may be coupled to the end 350 of the retainer 302 to hold the flow control assembly 304 within the bore 310.

To provide a seal between the sensing chamber 226 and the inlet chamber 244, the valve apparatus 202 includes a seal 356. The seal 356 (e.g., an O-ring) is disposed between the retainer 302 of the valve apparatus 202 and the valve body 208 of the fluid regulator 200. Additionally, the seal 356 is disposed between the sensing chamber 226 and the threads 308 of the retainer 302 to prevent impurities from flowing between the threads 308 the fluid flow passageway via the sensing chamber 226.

In operation, referring to FIGS. 2 and 3, the example fluid regulator 200 fluidly couples to, for example, an upstream pressure source providing a relatively high pressure fluid (e.g., a gas) via the inlet 210 and fluidly couples to, for example, a low pressure downstream device or system via the outlet 212. The fluid regulator 200 regulates the outlet pressure of the fluid flowing through the fluid regulator 200 to a desired pressure corresponding to the preset load provided by the adjustable load assembly 220.

To achieve a desired outlet pressure, the spring adjustor 236 is rotated (e.g., in a clockwise or counterclockwise direction) to increase or decrease the load exerted by the biasing element 232 on the first side 216 of the diaphragm 214. The load provided by the biasing element 232 is adjusted to correspond to a desired outlet pressure. With the reference pressure set, the sensing chamber 226 senses a pressure of the pressurized fluid at the outlet 212 via the passage 228, which causes the diaphragm 214 to move in response to pressure changes in the sensing chamber 226.

For example, as the downstream demand decreases, the pressure of the fluid at the outlet 212 increases. As the pressure of the pressurized fluid in the sensing chamber 226 increases, the pressure of the fluid exerts a force on the second side 222 of the diaphragm 214 to cause the diaphragm 214 and the biasing element 232 to move in a rectilinear motion away from the stem connector 344. In turn, the biasing element 332 of the valve apparatus 202 causes the poppet 330 to move toward the valve seat 318 to restrict fluid flow between the inlet 210 and the outlet 212. The portion 337 of the sealing surface 334 of the poppet 330 sealingly engages the seating surface 336 of the valve seat 318 to restrict or prevent fluid flow through the orifice 316 of the fluid regulator 200 as shown in FIG. 3.

As the downstream demand increases, the pressure at the outlet 212 decreases. When the pressure of the pressurized fluid in the sensing chamber 226 is less than the reference pressure or force exerted by the biasing element 232 on the first side 216 of the diaphragm 214, the diaphragm 214 moves, bends or flexes toward the valve body 208. In turn, the back-up plate 230 engages the stem connector 344 of the poppet 330 to move the poppet 330 away from the valve seat 318 to allow or increase fluid flow between the inlet 210 and the outlet 212. When the poppet 330 is furthest away from the valve seat 318 (e.g., at an open position), the orifice 316 allows or permits a maximum fluid flow capacity or fluid flow rate.

As noted above, the orifice 316 defines a maximum fluid flow capacity or maximum flow rate of the fluid regulator 200. For example, the maximum flow rate can be related to a flow coefficient (Cᵥ) that is used to classify or predict the flow rate through the fluid regulator 200 under a standard condition as noted above. In operation, the example orifice 316 is sized to provide a flow capacity associated with or characterized by a fluid flow coefficient of approximately 0.06. Further, the fluid flow path 322 is sized to support a maximum fluid flow rate permitted by the orifice 316 during operation.

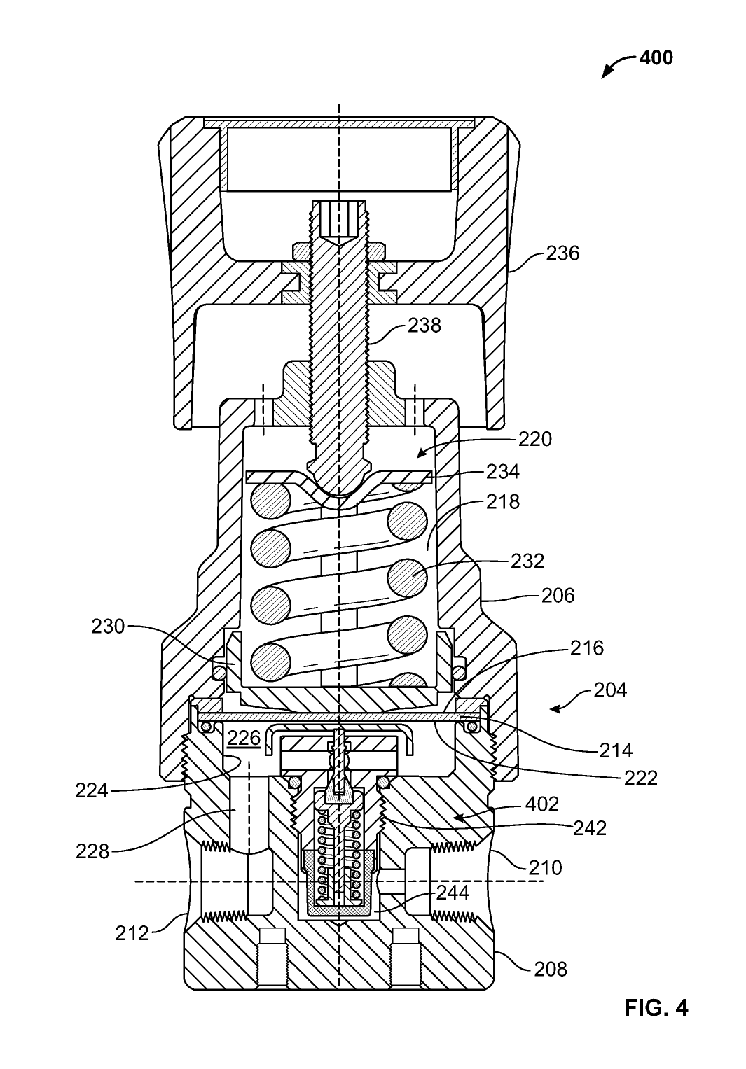

FIG. 4 illustrates an example fluid regulator 400 having a valve apparatus 402 described herein. Those components of the fluid regulator 400 and/or the valve apparatus 402 that are substantially similar or identical to the components of the fluid regulator 200 and/or the valve apparatus 202 described above in FIGS. 2 and 3 and that have functions substantially similar or identical to the functions of those components will not be described in detail again below. Instead, the interested reader is referred to the above corresponding descriptions.

Similar to the valve apparatus 202 of FIGS. 2 and 3, the valve apparatus 402 is a subassembly that is removably coupled to the valve body 208 to define at least a portion of the fluid flow passageway between the inlet 210 and the outlet 212. The valve apparatus 402 provides a different fluid flow performance, characteristic or capacity of the fluid regulator 400 than the fluid flow performance, characteristic or capacity of the fluid regulator 200 provided by the retainer 302 of FIGS. 2 and 3. For example, the valve apparatus 402 provides a fluid flow capacity or flow rate associated with or classified by a flow coefficient of approximately 0.2 when the valve apparatus 402 is coupled to the fluid regulator 400. In contrast, the valve apparatus 202 provides a fluid flow capacity or flow rate characterized by a flow coefficient of approximately 0.06 when coupled to the fluid regulator 200 of FIG. 2.

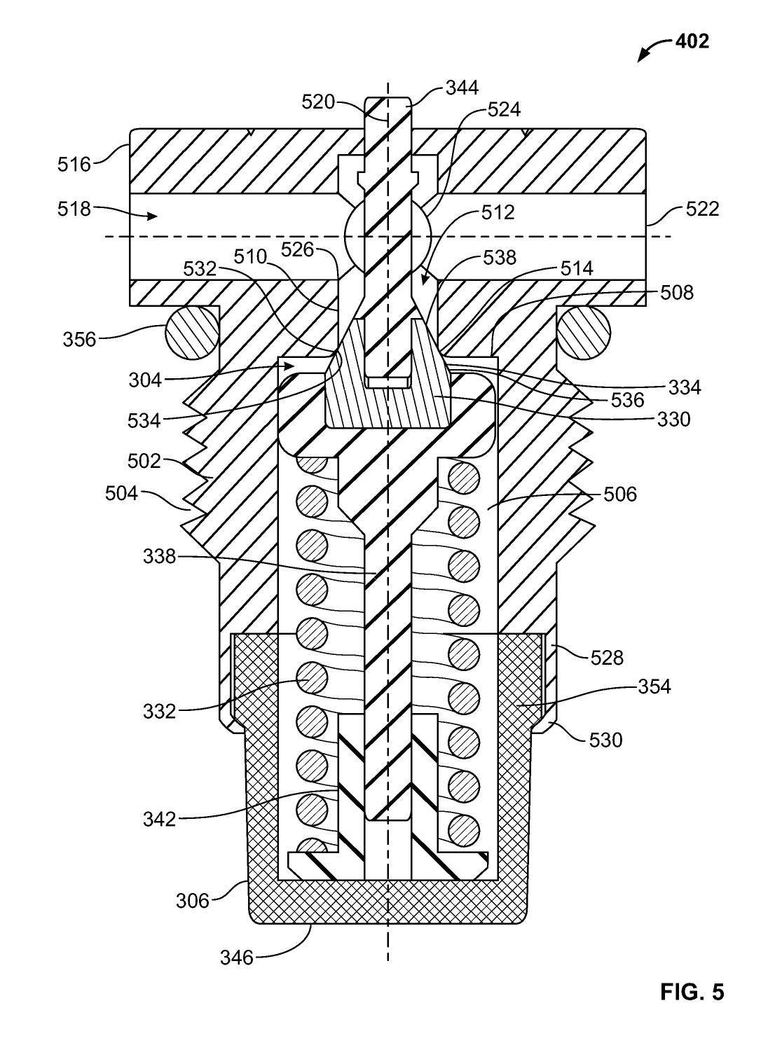

FIG. 5 is an enlarged view of the example valve apparatus 402 of FIG. 4. Referring to FIGS. 4 and 5, the valve apparatus 402 includes an interchangeable or replaceable housing or retainer 502, the flow control assembly 304 and the filter 306. The retainer 502 of the illustrated example is substantially similar to the retainer 302 of the valve apparatus 202 of FIGS. 2 and 3. In particular, the retainer 502 is interchangeable or replaceable with the retainer 302 of the valve apparatus 202 of FIGS. 2 and 3. For example, the retainer 502 may be replaced or interchanged with the retainer 302 of FIGS. 2 and 3 to affect or provide a different fluid flow capacity or flow rate of the fluid regulator 400.

The retainer 502 of the illustrated example has a cylindrically-shaped body having a threaded portion 504 to couple the valve apparatus 402 to the opening 242 of the valve body 208 of the fluid regulator 400. The retainer 502 includes a cavity or bore 506 to at least partially define the fluid flow passageway of the fluid regulator 400 when the valve apparatus 402 is coupled to the valve body 208. The retainer 502 and the bore 506 form a shoulder 508 having an opening 510 coaxially aligned with the bore 506 to define a fluid orifice 512 of the fluid flow passageway of the fluid regulator 400. In particular, the orifice 512 defines a fluid flow capacity or fluid flow characteristic of the fluid regulator 400. For example, the orifice 512 has a diameter or size to provide a flow capacity characterized by a fluid flow coefficient of approximately 0.2. Thus, the orifice 512 of the retainer 502 is sized larger than the orifice 316 of the retainer 302 of FIGS. 2 and 3. The shoulder 508 of the retainer 502 defines a valve seat 514 of the fluid flow passageway of the fluid regulator 400.

Further, to support a fluid flow rate associated with the fluid flow capacity or characteristic provided by the orifice 512, the retainer 502 includes a flange 516 having a fluid flow path 518. The fluid flow path 518 of the illustrated example is substantially perpendicular to the opening 510 and/or the bore 506 and is downstream from the valve seat 514. In particular, the fluid flow path 518 supports or allows a greater amount of fluid to flow to the sensing chamber 226 to support a fluid flow rate associated with the fluid flow capacity provided by the orifice 512. For example, to support a fluid flow rate provided by the orifice 512, the fluid flow path 518 may include a plurality of fluid flow paths radially spaced about an axis 520 of the flange 516. As shown, the fluid flow path 518 includes a first fluid flow path 522 adjacent a second fluid flow path 524 downstream of the valve seat 514. In this example, the first and second fluid flow paths 522 and 524 provide cross-flow paths. In other words, the first fluid flow path 522 is substantially perpendicular to the second fluid flow path 524. Both the first and second fluid flow paths 522, 524 fluidly couple an outlet 526 of the valve seat 514 and the sensing chamber 226. As shown, the retainer 502 has a T-shaped cross-sectional shape or profile. However, in other examples, the retainer 502 may have any other suitable cross-sectional shape or profile.

During assembly, the flow control assembly 304 is disposed within the bore 506. More specifically, the retainer 502 (e.g., the bore 506 and the shoulder 508) define a common flow control assembly interface to receive the flow control assembly 304. In particular, the poppet 330, the biasing element 332, the poppet retainer 338, the stem connector 344 and the spring seat 342 are disposed within the bore 506 of the retainer 502. The filter 306 is coupled to an end 528 of the retainer 502 that includes tabs, clips or fingers 530 to receive the enlarged portion 354 of the filter 306. To provide a seal between the sensing chamber 226 and the inlet chamber 244, the valve apparatus 402 includes the seal 356 (e.g., an O-ring) disposed between the threaded portion 504 and the flange 516.

In operation, the poppet 330 moves relative to the shoulder 508 or the valve seat 514 of the retainer 502. The sealing surface 334 of the poppet 330 engages a seating surface 532 of the valve seat 514. In this example, the sealing surface 334 of the poppet 330 has a profile or shape (e.g., a tapered profile) that is complementary to the profile or shape of the seating surface 532 (e.g., a tapered profile). When the poppet 330 is in the closed position to substantially restrict or prevent fluid flow through the orifice 512 as shown in FIGS. 4 and 5, a portion 534 of the sealing surface 334 of the poppet 330 engages the seating surface 532 of the valve seat 514. In contrast to the valve apparatus 202 of FIGS. 2 and 3, the poppet 330 engages the valve seat 514 along the portion 534 of the sealing surface 334. The portion 534 of the sealing surface 334 that engages the valve seat 514 is different than the portion 337 of the sealing surface 334 that engages the valve seat 318 of the valve apparatus 202 of FIGS. 2 and 3 because the size of the orifice 512 of the retainer 502 is larger than the size of the orifice 316 of the retainer 302. Thus, the example retainer 502 provides a different flow characteristic of the fluid regulator 400 by changing only the retainer (e.g., the retainer 302). In this example, the poppet 330 has a cone or tapered profile so that a larger sized orifice such as the orifice 512 seals toward a base 536 of the poppet 330 and the larger sized orifice 512 allows more fluid flow through the orifice 512, while a smaller orifice such as the orifice 316 seals toward an end 538 of the poppet 330 and the smaller sized orifice 316 allows relatively less fluid flow through the orifice 316.

Thus, unlike the fluid regulator 100 of FIG. 1, the retainer 302 of the valve apparatus 202 of FIGS. 2 and 3 can be interchanged or replaced with the retainer 502 of the valve apparatus 402 of FIGS. 4 and 5 to alter or affect a fluid flow capacity of the respective fluid regulators 200 and 400. Further, the retainers 302 or 502 may include one or more fluid flow paths to support a fluid flow rate provided by an orifice of a fluid regulator. In this manner, a different valve body (e.g., the valve body 208) having a larger fluid flow path is not required.

Further, the valve apparatus 402 may be interchanged with the valve apparatus 202 of the fluid regulator 200 of FIG. 2 to provide a fluid flow capacity or flow characteristic of the fluid regulator 200 that is characterized by a flow coefficient of 0.2. Likewise, the valve apparatus 402 of the fluid regulator 400 may be interchanged with the valve apparatus 202 of FIG. 2 to provide a fluid flow capacity or flow characteristic of the fluid regulator 400 having a flow coefficient of 0.06. In particular, only the retainers 302 and 502 need to be interchanged or replaced to change or affect a fluid flow capacity of a fluid regulator. Thus, the retainer 302 may be replaced with the retainer 502 to define a fluid flow capacity of the fluid regulator 200 having a flow coefficient of 0.2, and the retainer 502 may be replaced with the retainer 302 to define a fluid flow capacity of the fluid regulator 400 characterized by a flow coefficient of 0.06. In other words, because the retainers 302 and 502 define the respective orifices 316 and 512, only the retainers 302 and 502 need to be interchanged to change or affect a fluid flow capacity or performance of a fluid regulator. As a result, the valve apparatus described herein significantly reduce manufacturing and inventory costs.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A valve apparatus for use with a fluid regulator comprising:
a first retainer to be removably coupled to a fluid flow passageway of the fluid regulator between an inlet and an outlet, the first retainer comprises a first housing having a first bore to receive a flow control assembly, the retainer having a first opening coaxially aligned with the first bore to define a first orifice of the fluid flow passageway when the retainer is coupled to the fluid regulator; and
a second retainer different than and interchangeable with the first retainer, wherein the second retainer comprises a second housing having a second bore to receive the flow control assembly, the second retainer having a second opening coaxially aligned with the second bore to define a second orifice of the fluid flow passageway when the second retainer is coupled to the fluid regulator, and wherein the first retainer provides a first fluid flow characteristic of the fluid regulator and the second retainer provides a second fluid flow characteristic of the fluid regulator different than the first fluid flow characteristic.

2. A valve apparatus of claim 1, wherein the first retainer includes a first fluid flow path that is substantially perpendicular to the first orifice and is to be in fluid communication with a sensing chamber of the fluid regulator when the first retainer is coupled to the fluid regulator.

3. A valve apparatus of claim 2, wherein the second retainer includes a second fluid flow path and a third fluid flow path that are substantially perpendicular to the second orifice and are both to be in fluid communication with a sensing chamber of the fluid regulator when the second retainer is coupled to the fluid regulator.

4. A valve apparatus of claim 3, wherein the third fluid path is substantially perpendicular to the second fluid flow path.

5. A valve apparatus of claim 1, wherein the first retainer provides a fluid flow coefficient of approximately 0.06 and the second retainer provides a fluid flow coefficient of approximately 0.2.

6. A valve apparatus of claim 1, further comprising the flow control assembly, the flow control assembly comprising a poppet, a biasing element, and a spring seat.

7. A valve apparatus of claim 6, wherein the poppet engages the first opening along a first portion of a first sealing surface when coupled to the first retainer, wherein the poppet engages the second opening along a second portion of a second sealing surface when the poppet is coupled to the second retainer, and wherein the first portion is different than the second portion.

8. A valve apparatus of claim 1, further comprising a closure member to hold the flow control assembly within the first retainer or second retainer.

9. A valve apparatus of claim 8, wherein the closure member comprises a filter that couples to an end of the first retainer or an end of the second retainer to hold the flow control assembly in the first retainer or the second retainer, respectively.

10. A valve apparatus comprising:
a valve cartridge removably coupled to a valve body of a fluid regulator to define at least a portion of a fluid flow passageway between an inlet and an outlet of the valve body, the valve cartridge comprising:
a plurality of different and interchangeable retainers for use with the fluid regulator, each retainer from the plurality of retainers having an orifice to define a different respective fluid flow capacity of the fluid regulator;
a flow control assembly disposed within a cavity of a first retainer selected from the plurality of retainers; and
a closure member coupled to an end of the first retainer to hold the flow control assembly within the cavity.

11. A valve apparatus of claim 10, wherein the first retainer comprises a body having a T-shaped cross-sectional shape.

12. A valve apparatus of claim 10, wherein each retainer includes a fluid flow path that is substantially perpendicular to the orifice.

13. A valve apparatus, comprising:
a first retainer having a first cavity to receive a movable flow control member and a first shoulder that defines a first valve seat, the first valve seat defining a first orifice providing a first fluid flow capacity of the fluid regulator when the first retainer is coupled to the fluid regulator;
a poppet disposed within the first cavity and movable relative to the first valve seat to control fluid flow across the first orifice;
a seal coupled to an end of the first retainer to retain the poppet within the first cavity of the first retainer; and
a second retainer interchangeable with and different than the first retainer, the second retainer having a second cavity to receive the flow control member and a second shoulder that defines a second valve seat, the second valve seat defining a second orifice that provides a second fluid flow capacity when the second retainer is coupled to the fluid regulator, the first fluid flow capacity being different than the second fluid flow capacity.

14. A modular valve apparatus of claim 13, wherein the first retainer comprises a body having a T-shaped cross-sectional shape.

15. A modular valve apparatus of claim 14, wherein the first retainer includes clips adjacent an end of the body to receive a filter.

16. A modular valve apparatus of claim 13, wherein the first retainer comprises a first fluid path to support a first flow capacity and the second retainer comprises a second fluid path to support a second flow capacity different than the first flow capacity.

17. A modular valve apparatus of claim 16, wherein the first fluid path is substantially perpendicular to the first orifice and downstream from the first valve seat.

18. A modular valve apparatus of claim 16, wherein the second fluid flow path of the second retainer comprises a fluid cross-flow path downstream from the second valve seat.

19. A method of coupling a valve cartridge for use with a fluid regulator, the method comprising:
removing a flow control member from a first retainer of the valve cartridge;
selecting a second retainer from the plurality of retainers, the second retainer having a second orifice to define a second fluid flow capacity different than the first fluid flow capacity provided by the first retainer; and
coupling the flow control assembly to the flow control assembly interface of the second retainer.

20. A method of claim 19, further comprising coupling the valve cartridge having the second retainer to the fluid regulator.
